(19) United States
(12) Patent Application Publication
(10) Pub. No.: US 2019/0265948 A1
(43) Pub. Date: Aug. 29, 2019

(54) METHOD AND SYSTEM FOR MANAGING VEHICLE USER PROFILES

(71) Applicant: GM GLOBAL TECHNOLOGY OPERATIONS LLC, Detroit, MI (US)

(72) Inventors: Anurag Goyal, Plymouth, MI (US); Andrew J. Motika, Royal Oak, MI (US)

(21) Appl. No.: 15/906,432

(22) Filed: Feb. 27, 2018

(51) Int. Cl. G06F 7/32; G06F 17/30; H04L 29/08

(52) U.S. Cl. CPC G06F 7/32; H04L 67/12; H04L 67/306; G06F 17/30598

(57) ABSTRACT

A system and method for managing vehicle user profiles. The system and method may merge two or more vehicle profiles associated with a vehicle by determining whether there is a plurality of vehicle user profiles associated with the vehicle, obtaining feature information from the plurality of vehicle user profiles, analyzing the feature information from the plurality of vehicle user profiles, adding matching features from feature categories of the plurality of vehicle user profiles to a merge profile, and presenting features to a vehicle occupant based on the merge profile.

### INTRODUCTION

The technical field relates to management of vehicle user pPatentrofiles, and more particularly, to systems and methods for merging multiple vehicle user profiles and presenting features to vehicle users based on the merged profiles.

Vehicle user profiles may contain a variety of information relating to personalized preferences of one or more users or occupants of the vehicle. Reconciling multiple vehicle user profiles in a more cohesive manner can allow for a more personalized experience. Further, the way in which a merged profile is created and customized may be adapted to further enhance the way in which features are presented to vehicle occupants.

### SUMMARY

According to an embodiment, there is provided a method of managing vehicle user profiles. The method includes the step of determining whether there is a plurality of vehicle user profiles associated with the vehicle, and when it is determined that there is a plurality of vehicle user profiles associated with the vehicle, obtaining feature information from the plurality of vehicle user profiles. The method also includes the step of analyzing the feature information from the plurality of vehicle user profiles. The feature information includes features from one or more feature categories. The method also includes the step of adding matching features from each feature category of the one or more feature categories of the plurality of vehicle user profiles to a merge profile, and presenting features to a vehicle occupant based on the merge profile.

In a more particular embodiment, the method may further comprise the step of determining a preference for remaining features not matched in the adding step.

In another more particular embodiment, the method may comprise a second adding step of adding remaining features to the merge profile based on the determined preference.

In another more particular embodiment, the feature information includes a feature type, the feature type being a granular feature type or a non-granular feature type.

In another more particular embodiment, the granular feature type includes divisible inner contents containing a plurality of content items.

In another more particular embodiment, a clustering algorithm is used to determine the preference for one or more granular feature types.

In another more particular embodiment, clusters include music genres for radio stations and each radio station is a cluster point.

In another more particular embodiment, granular feature type features are optimized in the merge profile and non-granular feature type features are automatically uploaded to the merge profile depending on the determined preference.

In another more particular embodiment, the determined preference includes a time factor that accounts for the timing of a requested merge.

In another more particular embodiment, the feature categories include vehicle environmental features, audio features, communication features, and navigation features.

In another more particular embodiment, the method further comprises the step of providing an option to the vehicle occupant to merge one or more of the plurality of vehicle user profiles.

In another more particular embodiment, the method further comprises the step of providing an option to the vehicle occupant to send a vehicle user profile to a shared-ride platform.

In another more particular embodiment, the method further comprises the step of using a sent vehicle user profile to the shared-ride platform as a primary vehicle user profile for building the merge profile.

In another more particular embodiment, the merge profile is based from a primary vehicle user profile. Features common to the primary vehicle user profile and a secondary vehicle user profile are prioritized in the merge profile, features of the primary vehicle user profile that are not present in the secondary vehicle user profile are not prioritized in the merge profile, and features of the secondary vehicle user profile that are not present in the primary vehicle user profile are not part of the merge profile.

In another more particular embodiment, a primary vehicle user profile is associated with a primary driver of the vehicle, and any safety-related features in the merge profile correspond to the safety-related features of the primary vehicle user profile.

According to another embodiment, there is provided a method of managing vehicle user profiles for a vehicle. The method includes prompting an occupant of the vehicle to initiate a merge of a plurality of vehicle user profiles and receiving authorization to carry out the merge. Feature information is analyzed from the plurality of vehicle user profiles, wherein the feature information includes features from one or more feature categories. The method further includes adding matching features from each feature category of the one or more feature categories of the plurality of vehicle user profiles to a merge profile, determining a preference for remaining features not matched in the prior adding step, adding remaining features to the merge profile based on the determined preference, and presenting features to the occupant of the vehicle based on the merge profile.

In a more particular embodiment, the method further comprises the step of presenting the occupant of the vehicle an option to cancel use of the merge profile.

In another more particular embodiment, the option to cancel use of the merge profile is presented to the occupant of the vehicle via a mobile device.

According to another embodiment, there is provided a system for managing vehicle user profiles in a vehicle. The system comprises an infotainment system located at the vehicle, a database containing a plurality of vehicle user profiles, a profile analyzing tool configured to analyze feature information from the plurality of vehicle user profiles, and a merge profile building tool configured to build a merge profile from the plurality of vehicle user profiles by adding matching features from one or more feature categories from each of the plurality of vehicle user profiles to the merge profile. Features of the merge profile are presented to one or more vehicle occupants through the infotainment system.

In a more particular embodiment, the database, the profile analyzing tool, and the merge profile building tool are located at a back-end facility.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting one example embodiment of a system that is capable of utilizing the methods disclosed herein;

FIG. 2 is a flow chart depicting an embodiment of a method of managing vehicle user profiles which may be used with the system of FIG. 1; and

FIG. 3 schematically illustrates a simplified merge profile in accordance with one embodiment.

### DETAILED DESCRIPTION OF THE ILLUSTRATED EMBODIMENTS

The systems and methods described below manage various vehicle user profiles by creating a merged profile that may be used to present vehicle features to the vehicle occupants. The vehicle user profile management systems and methods may be used to process vehicle user profiles and present features to vehicle occupants in a more personalized and customizable fashion than other methods which create personalized feature profiles. Further, adjusting a primary vehicle user's profile for certain occupants may be time-consuming and can alter the primary vehicle user's personalized settings. Instead of having to alter a primary vehicle user's profile to account for the preferences of a passenger, for example, the present methods and systems can allow for a more efficient presentation of features without disturbing the vehicle user's base profile. Additionally, the manner in which features are analyzed, categorized, and prioritized may result in more efficient processing and use of system resources.

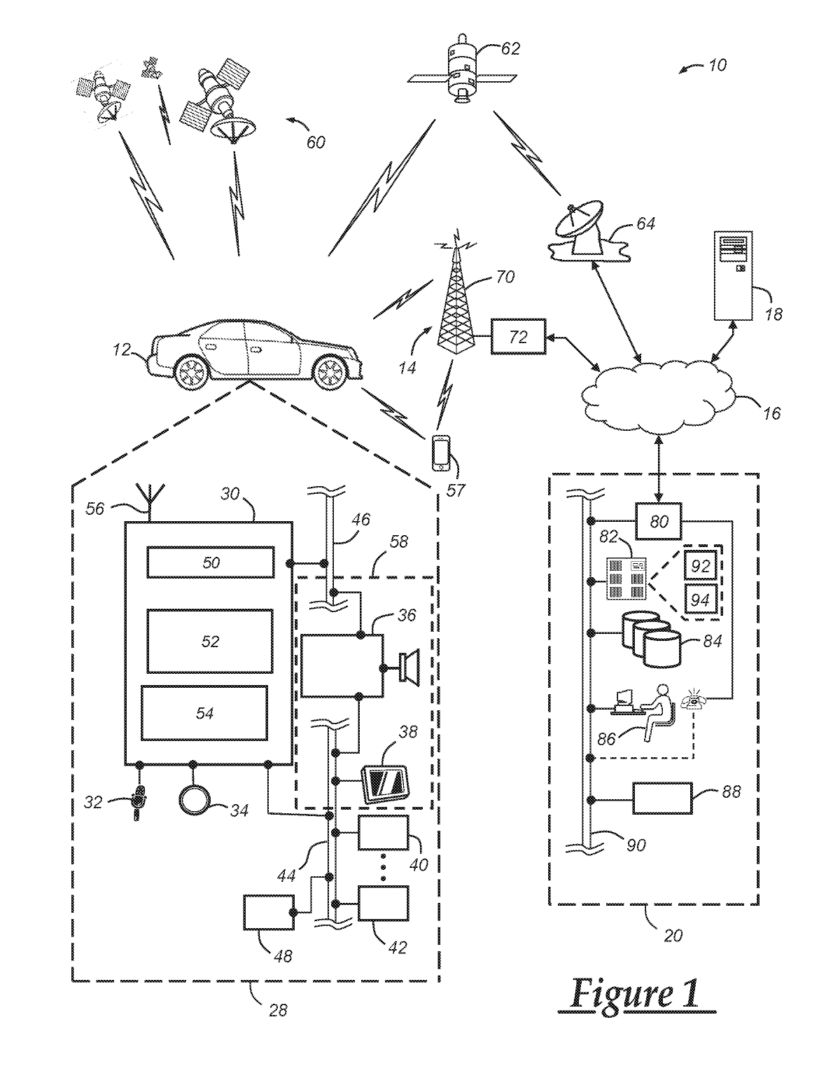

With reference to FIG. 1, there is shown an operating environment that comprises a vehicle communications system 10 that can be used with the method and systems disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other system configurations are certainly possible, and systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36 and a visual display 38 which are part of an infotainment system 58, a GPS module 40, a body control module (BCM) 48, as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device installed in the vehicle that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different features or services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services.

Telematics unit 30 can be used to provide a diverse range of vehicle services that involve wireless communication to and/or from the vehicle. Such services include: transmission of a merge profile from the call center 20; turn-by-turn directions and other navigation-related services that are provided in conjunction with the GPS-based vehicle navigation module 40; airbag deployment notification and other emergency or roadside assistance-related services that are provided in connection with one or more collision sensor interface modules such as the BCM 48; diagnostic reporting using one or more diagnostic modules; and infotainment-related services where music, webpages, movies, television programs, videogames and/or other information is downloaded by the infotainment system 58 and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 is a VSM which receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Body control module 48 is a VSM that may control and/or monitor various features relating to the environment of vehicle 12, including lights, security features, door locks, climate control, as well as other environmental qualities relating to the vehicle 12. The body control module 48 may be connected to other vehicle electronics 28 or VSMs 42 via the bus 44. The respective inputs and outputs to and from the body control module 48 may vary depending on the desired implementation, and in some embodiments, the body control module 48 may not be a standalone component, but instead, the various features relating to the environment of the vehicle 12 may be controlled by a number of distributed, application-specific modules.

Apart from the audio system 36, GPS module 40, and body control module 48, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, and another VSM 42 can be a powertrain control module that regulates operation of one or more components of the vehicle powertrain. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment system 58. Visual display 38 is preferably a graphics display, such as a touch screen on the instrument panel or a heads-up display reflected off of the windshield, and can be used to provide a multitude of input and output functions. Further, it is possible for any of the other VSMs depicted in FIG. 1, or those not depicted, to also be part of the infotainment system 58. Various other vehicle user interfaces can also be utilized in conjunction with the infotainment system 58 or other VSMs, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

A mobile device 57 belonging to a vehicle occupant may interact with the vehicle 12, such as via the telematics unit 30, or with the wireless carrier system 14. The mobile device 57 can include computer processing capability, a transceiver capable of communicating using a short-range wireless protocol, and a visual mobile device display. The mobile device 57 also includes one or more microprocessors that execute machine code to generate logical output. Examples of the mobile device 57 include the iPhone manufactured by Apple and the Galaxy manufactured by Samsung, as well as others. While the mobile device 57 may include the ability to communicate via cellular communications using the wireless carrier system 14, this is not always the case. For instance, Apple manufactures devices such as the various models of the iPad and iPod Touch that include the processing capability, a display, and the ability to communicate over a short-range wireless communication link. However, the iPod Touch™ and some iPads™ do not have cellular communication capabilities. Even so, these and other similar devices may be used or considered a type of wireless device, such as the mobile device 57, for the purposes carrying out one or more steps of the methods described herein.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a client computer used by the vehicle owner or other subscriber for such purposes as accessing or receiving vehicle data or to setting up or configuring subscriber preferences or otherwise controlling vehicle features; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is a back-end facility designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

Server 82 may include a software framework for accommodating a profile analyzing tool 92 and a merge profile building tool 94. While these tools are schematically shown as being separate in FIG. 1, it is possible for one software framework or platform to execute both analyzing and profile building, and accordingly, the profile analyzing tool 92 and the merge profile building tool 94 would be executed via the same platform. Similarly, it is possible for the profile analyzing tool 92 and the merge profile building tool 94 to be executed via separate servers or processing devices, even those remote from the call center 20. For example, it is possible for profile analyzing tool 92 or the merge profile building tool 94 to be cloud- or web-based systems or implemented in some other operable format.

Database 84 may be a vehicle information database that stores feature information relating to a plurality of user profiles for use with the present systems and methods. Database 84 can store account information such as subscriber authentication information, vehicle identifiers, profile records, behavioral patterns, and other vehicle information. As with server 82, it is possible for the database 84 to be implemented in other operable fashions, such as a cloud- or web-based system that is not directly related to the call center 20. Further, it is possible for the methods and systems herein to extract profile-related or feature information from a number of discrete databases. In one embodiment, the vehicle information database is any storage implementation or source containing vehicle-related information.

Server 82 and its database 84 may be implemented in a known manner using an electronic processor with non-transitory computer readable memory storing program code that, upon execution by the processor, carries out the methods described herein, and with that same memory or a separate non-transitory computer readable memory used as database 84 to store the data used in the methods described herein, such as the vehicle user profiles, which are described in greater detail below. The server 82 may thus be configured as a special purpose analyzer that includes the profile analyzing tool 92 and merge profile building tool 94, both of which may be implemented using the processor operating under control of the program code to provide a system that carries out some or all of the steps of method 100 described below.

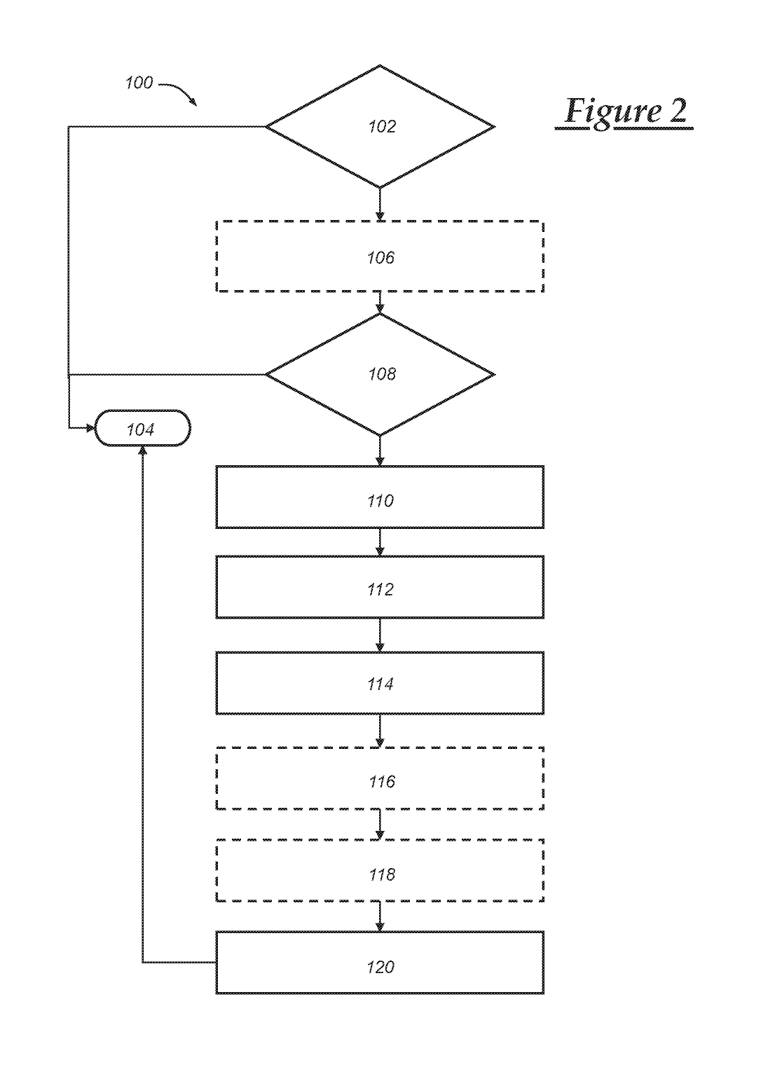

Turning now to FIG. 2, there is shown an exemplary implementation of a method 100 for managing vehicle user profiles. The method 100 may be used to present feature options to vehicle occupants in a more efficient manner, by automatically and effectively building merge profiles that account for a plurality of vehicle user profiles. The increase in efficiency may correlate with a reduction in time and memory intensive computing requirements involved in profile analysis. Further, the methods may result in a more customized and streamlined presentation of features to vehicle occupants.

The method begins at step 102 and asks whether there is a plurality of vehicle user profiles. Step 102 may be accomplished via a prompt on the display screen 38 of the infotainment system 58, or may be carried out automatically such as by detecting keys (e.g., sensing the driver's key and a secondary key both in the vehicle constitutes a determination there are a plurality of vehicle user profiles to be merged), occupancy sensors (e.g., sensing a passenger in another seat in the vehicle constitutes a determination that there are a plurality of vehicle user profiles), or any other operable method.

Vehicle user profiles may contain features that a vehicle occupant has used or preferred in the past. Features may be a part of one or more feature categories. In one embodiment, there may only be a single feature category (e.g., customizable features capable of being added to a merge profile or all vehicle features, etc.). In another embodiment, there may be a number of feature categories such as vehicle environmental features, audio features, communication features, and navigation features. Vehicle environmental features may include, but are not limited to, air quality sensor tolerance, auto fan maximum speed, remote start auto cool seats, remote start auto heat seats, language, display mode, prompt type, ambient lighting, audible touch feedback, audio volume limit, chime volume, and/or gesture indication. Audio features may include, but are not limited to, HD Radio™ settings, radio data system (RDS) settings, bass, midrange, treble, fade, balance, maximum startup volume, number of audio favorites, favorite AM frequency, favorite FM frequency, favorite digital audio broadcasting (DAB) station, favorite satellite digital audio radio service (SDARS) channel, favorite app station, favorite Pandora™ station, favorite media artist, favorite media song, favorite media album, favorite media playlist, favorite media podcast, favorite media genre, favorite media audio book, favorite media video, favorite media compilation, favorite media composer, favorite media folder, radio favorites, DAB announcements, DAB to DAB linking, DAB to FM linking, sound mode, tune mix, and/or tune start. Communication features may include number of phone favorites, favorite phone number, favorite contact name, teletypewriter (TTY) mode, speech-based interactive prompts, and/or speech-based voice command help displays. Navigation features may include, but are not limited to, favorite locations, favorite destination, favorite search term point of interest (POI), favorite POI category, favorite POI chain, favorite search term for addresses, favorite search term for POIs, augmented reality navigation display, display of crowd sourced incidents, road safety alerts, predictive destination cards display, POI icons on map, prompts on active calls, traffic alerts, and/or traffic on map. Other features and categories beyond this example are certainly possible.

If it is determined in step 102 that there is only one vehicle user profile (e.g., a primary vehicle user profile associated with the driver or only a single occupant present in the vehicle 12), the method may end at step 104. Accordingly, if the method ends after step 102 and proceeds to ending at step 104, the primary vehicle user profile or some sort of default may be used to present features to the driver or another vehicle occupant. If it is determined in step 102 that there is more than one vehicle user profile (e.g., a primary vehicle user profile and a secondary user profile associated with a second driver of the vehicle or a common passenger, to cite two examples), the method may continue to optional step 106.

In step 106, an option to merge vehicle user profiles is provided. This step is shown as optional, as there may be some situations where multiple profiles are automatically merged. Preferably, however, a merge option is provided to the vehicle occupant(s). The option to merge may be provided through the infotainment system 58, or on the visual display 38. Alternatively, the option to merge may be provided via a mobile device 57 belonging to a vehicle occupant. The option to merge may list the plurality of vehicle user profiles and allow a user to select two or more, or all, of the vehicle user profiles that will be analyzed for the merge profile. The option to merge may specify only particular feature categories to merge or only particular features to merge. For example, a vehicle occupant could have the option to merge audio features without merging navigation features. Other choices or variations for the option presentation are certainly possible.

In some embodiments, the option to merge may also provide an option to upload a vehicle user profile. This may provide the benefit of allowing a new occupant of the vehicle to add his or her vehicle user profile to the plurality of profiles to be merged. Vehicle user profiles may be associated with an online platform so that a user can customize his or her preferences using a web-based program or application. In one embodiment, the method 100 may include the step of providing an option to a vehicle occupant to send a vehicle user profile to a shared-ride platform. In this embodiment, if users of a ride sharing service enter into a vehicle 12 equipped with the disclosed system 10 and/or methods 100, they can merge profiles with the driver or other vehicle occupants. It may be desirable in this embodiment to have the vehicle profile that is sent from the ride sharing occupant to the shared-ride platform to be a primary vehicle user profile for building the merge profile. As will be detailed further below, the primary vehicle user profile can serve as a basis for the merge profile and may favor the inclusion of certain features in the merge profile over features in one or more secondary vehicle user profiles. In another embodiment, if two passengers are ride sharing, both of their vehicle user profiles may be favored in a merge profile over the vehicle user profile of the driver. Variances regarding the presentation of merge-based options may be developed and/or customized depending on the desired implementation.

Step 108 of the method asks whether a merge is to be initiated. If a merge is not initiated, the method may proceed to ending at step 104. As described above, at step 104, the primary vehicle user profile or some sort of default may be used to present features to the driver or another vehicle occupant. Alternatively, if at step 108 a request or authorization to merge is received, the method continues to step 110.

In step 110, feature information from the vehicle user profiles to be merged is obtained. Data relating to feature information may be stored at an off-site location from the vehicle 12, such as at database 84 at the back-end facility or call center 20. It is also possible for data relating to feature information of the vehicle user profiles to be stored locally at the vehicle 12, such as in memory 54. The feature information may include features from one or more feature categories, examples of which are described above with respect to step 102. Feature information may also include granular feature types or non-granular feature types. Granular feature types include divisible inner contents containing a plurality of content items. Non-granular feature types typically do not have inner contents which can be optimized to more fully merge the feature. To cite one example, favorite radio stations may be considered a granular feature whereas favorite contacts may be considered a non-granular feature. In this example, radio stations may be sorted into different genres, different particular stations, etc. Accordingly, in the merge profile, features can be sorted based on these different divisible inner contents (e.g., content items such as radio stations may be sorted based on the number of the station and/or the genre of the station). Oftentimes, granular feature types are broader than non-granular feature types, but this is not always the case.

Feature information obtained in step 110 may also include other information relating to the features such as time of day or time of year that a feature is used. For example, talk-based radio stations may be used more often in the morning so that a vehicle occupant can obtain traffic reports or the like. In another example, remote cooled seats may be used in warmer summer months, whereas remote heated seats may be used in colder winter months. Other feature information may include geographic-based feature information. Continuing with the example above, remote heated seats may not be preferred in warmer climates, or in a warmer climate, cooler maximum temperatures for the climate control system may be preferred. Other examples are possible as well.

Step 112 involves analyzing feature information, including features from one or more feature categories, from the plurality of vehicle user profiles. This step may be performed using the profile analyzing tool 92. This step may include determining which features are granular feature types and which features are non-granular feature types. In one embodiment, granular feature types may be optimized in later steps of the method 100, whereas non-granular feature types may be automatically updated based on the merge profile that is ultimately created. Step 112 may also involve discerning a primary vehicle user profile from a secondary vehicle user profile or other tertiary, quaternary, etc. vehicle user profiles. In most instances, a primary driver of the vehicle will have the primary vehicle user profile. In some instances, however, as described above with respect to a ride-sharing scenario, it may be desirable for a passenger to have the primary vehicle user profile. Also, step 106 may provide an option to designate a primary vehicle user profile, a secondary vehicle user profile, etc. in some circumstances.

Step 114 begins building the merge profile, and this step, as well as steps 116 and 118, may be accomplished with the merge profile building tool 94. More particularly, step 114 involves adding matching features from each analyzed feature category to a merge profile. For example, if there is a primary vehicle user profile and a secondary vehicle user profile to be merged, and both profiles include the same favorite contact for their communication features, then the favorite contact will be added to the merge profile. If, for audio features, both profiles include the same favorite media album, the album will be added to the merge profile. If, for vehicle environmental features, both profiles include the same ambient lighting settings, those ambient lighting settings will be added to the merge profile. If, for navigation features, both profiles have the same favorite destination (e.g., a husband and wife have the same “home” destination), the favorite destination will be added to the merge profile. These are merely examples, and other examples are certainly possible. This step may involve the addition of matching features to the merge profile for all profiles and/or feature categories and/or features to be merged.

Step 116 of the method 100 involves determining a preference for remaining features not added in step 114. This step is shown as optional in this embodiment. For example, it is possible for the merge profile to only include those features matched and added in step 114, and the method to continue to step 120 to present features to occupants based on the merge profile. In embodiments where step 116 is performed, a number of different ways for determining the preference for remaining features are possible. One example involves using the primary vehicle user profile and preferring non-matched features of the primary vehicle user profile over non-matched features of the secondary vehicle user profile. In this example, the merge profile may be based from a primary vehicle user profile such that features common to the primary vehicle user profile and a secondary vehicle user profile are prioritized in, or added to, the merge profile. Features of the primary vehicle user profile that are not present in the secondary vehicle user profile (i.e., not matched) are not prioritized in the merge profile, but are still added to the merge profile. And, features of the secondary vehicle user profile that are not present in the primary vehicle user profile are not added to the merge profile (i.e., for any non-matched features, the default adds the feature from the primary vehicle user profile). In a similar embodiment, when a primary vehicle user profile is associated with a primary driver of the vehicle, any safety-related features in the merge profile correspond to the safety-related features of the primary vehicle user profile (i.e., in some embodiments, for safety-related features, the primary vehicle user profile is always preferred). Safety-related features may include road safety alerts, blind spot or lane departure warnings, use of a backup camera or any other customizable safety-related feature.

In some embodiments, if granular feature types are distinguished or otherwise differentiated from non-granular feature types, step 116 may involve automatically uploading non-granular feature type features to the merge profile if there is a match, whereas with granular feature type features, the inner contents may be optimized in later steps of the method. To cite an example of a granular feature type, if two vehicle user profiles have the same favorite music genre (e.g., rock), different rock-based radio stations may be optimized in later steps of the method to determine how to reconcile different preferences for the individual stations. With a non-granular feature type, such as favorite artist, if there is a match between the two profiles for favorite artist, that artist will be automatically uploaded in the merge profile and will be presented to the vehicle occupants via the merge profile.

In one embodiment, determining the preference may include the use of a time factor that accounts for the timing of a requested merge. As addressed above, if the merge is initiated in step 108 in the morning, certain features may be preferred over other features, such as talk radio stations over music radio stations. Similarly, determining the preference may include the use of a geographic factor that accounts for the location of a requested merge. In one example, climate control temperature settings may prefer lower settings from one or more of the vehicle user profiles if the vehicle 12 is located in a warm climate. Implementation of other examples is also possible.

In another embodiment, determining the preference may include weighing likability of certain features or particular content items within features. This may be accomplished in any feasible way which discerns preferred features from non-preferred features and may use any operable algorithm, method, or process to organize the remaining features not added in step 114. In one preferred example, a clustering algorithm may be used. A clustering algorithm may be more useful when processing granular feature types. More particularly, in one implementation, it is possible for clusters to include music genres for radio stations and then each radio station is a cluster point. Radio stations within a particular cluster may be preferred over other stations that are a further distance from the general cluster. In another example, scaling or blending may be used to determine the preference of remaining features. For example, if a primary vehicle user profile prefers one maximum fan speed, and the secondary vehicle user profile prefers a lower maximum fan speed, a maximum fan speed that is somewhere in between may be added to the merge profile. Scaling or blending may also be used for audio features such as bass, midrange, treble, fade, balance, and maximum startup volume. Certain features may have particular methods to determine preference, whereas other features may have a different method to determine preference. Alternatively, only one method for determining preference may be used.

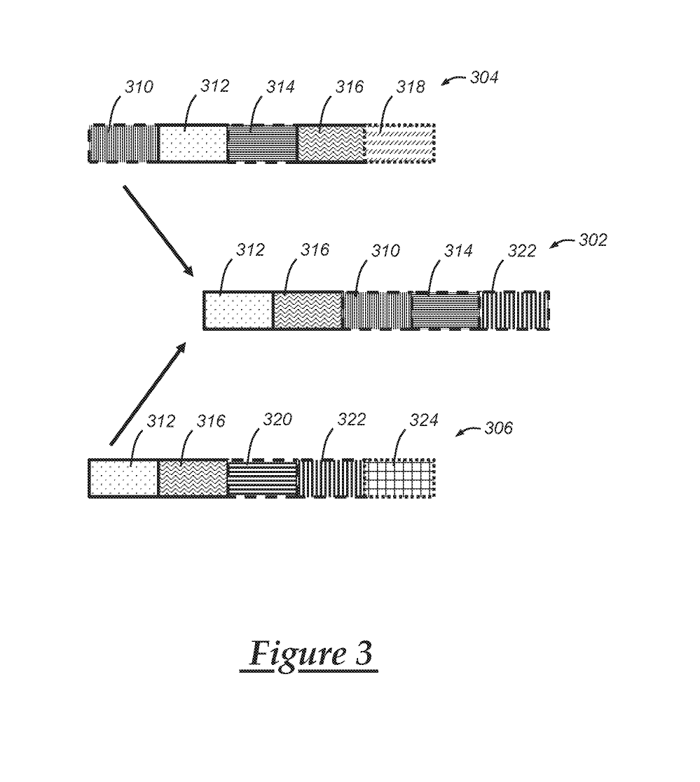

Step 118 involves adding remaining features to the merge profile based on the preference determined in step 116. Preferred features or optimized features may be added depending on outcomes of the clustering algorithm, scaling, blending, etc. One way in which features may be added is illustrated in FIG. 3. FIG. 3 schematically illustrates a simplified optimization-based merge profile 302 based on a primary vehicle user profile 304 and a secondary vehicle user profile 306. In this merge profile 302, only radio stations are merged. The primary vehicle user profile 304 consists of a first rock station 310 (vertical internal pattern), a pop station 312 (dotted internal pattern), a first talk station 314 (horizontal internal pattern), a sports station 316 (chevron internal pattern), and a hip hop station 318 (diagonal slashes internal pattern). The secondary vehicle user profile 306 consists of the first pop station 312, the sports station 316, a second talk station 320 (bold horizontal internal pattern), a second rock station 322 (bold vertical internal pattern), and a country station 324 (grid internal pattern). The merge profile 302 consists of matching features (solid outline) first—namely, the pop station 312 and the ports station 316. The merge profile 302 then contains preferred genres, but not necessarily matching stations (dashed outlines). More particularly, each profile 304, 306 includes both rock and talk stations, albeit different particular stations. The merge profile 302 thus includes the first rock station 310 from the primary profile, the first talk station 314, and then the second rock station 322. If, as illustrated, there is only room for five stations, the method may preference the rock genre over the talk genre, since the primary profile 302 includes a rock genre station as its first station 310. Stations not matched or preferred (i.e., the hip hop station 318 and the country station 324 with dotted outlines) are not added to the merge profile 302.

Step 120 of the method involves presenting features to users or vehicle occupants based on the merge profile. Continuing with the example illustrated in FIG. 3, the merge profile 302 will be presented to the vehicle occupants via infotainment system 58, such as via options on display screen 38. Depending on the type of feature included in the merge profile, the way in which the feature is presented to the vehicle occupants will vary. For example, certain navigation features may be implemented via the GPS module 40 or vehicle environmental features may be implemented via the body control module 48. Communication features may be implemented via the infotainment system 58 and/or the telematics unit 30.

The method 100 may end at step 104, and this may be accomplished by presenting a “merge exit” or “merge cancellation” option to the vehicle occupants, via mobile device 57 or on display screen 38, to cite two examples. In other embodiments, the merge may be time-based or route-based. For example, in a ride sharing scenario, the merge may end when the ride sharing route ends or when the ride sharing occupant leaves the vehicle. Other options for ending the method 100 are certainly possible.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of managing vehicle user profiles for a vehicle, comprising the steps of:
determining whether there is a plurality of vehicle user profiles associated with the vehicle;
when it is determined that there is a plurality of vehicle user profiles associated with the vehicle, obtaining feature information from the plurality of vehicle user profiles;
analyzing the feature information from the plurality of vehicle user profiles, wherein the feature information includes features from one or more feature categories;
adding matching features from each feature category of the one or more feature categories of the plurality of vehicle user profiles to a merge profile; and
presenting features to a vehicle occupant based on the merge profile.

2. The method of claim 1, further comprising the step of determining a preference for remaining features not matched in the adding step.

3. The method of claim 2, further comprising a second adding step of adding remaining features to the merge profile based on the determined preference.

4. The method of claim 3, wherein the feature information includes a feature type, the feature type being a granular feature type or a non-granular feature type.

5. The method of claim 4, wherein the granular feature type includes divisible inner contents containing a plurality of content items.

6. The method of claim 5, wherein a clustering algorithm is used to determine the preference for one or more granular feature types.

7. The method of claim 6, wherein clusters include music genres for radio stations and each radio station is a cluster point.

8. The method of claim 3, wherein granular feature type features are optimized in the merge profile and non-granular feature type features are automatically uploaded to the merge profile depending on the determined preference.

9. The method of claim 2, wherein the determined preference includes a time factor that accounts for timing of a requested merge.

10. The method of claim 1, wherein the feature categories include vehicle environmental features, audio features, communication features, and navigation features.

11. The method of claim 1, further comprising the step of providing an option to the vehicle occupant to merge one or more of the plurality of vehicle user profiles.

12. The method of claim 11, further comprising the step of providing an option to the vehicle occupant to send a vehicle user profile to a shared-ride platform.

13. The method of claim 12, further comprising the step of using a sent vehicle user profile to the shared-ride platform as a primary vehicle user profile for building the merge profile.

14. The method of claim 1, wherein the merge profile is based from a primary vehicle user profile, and wherein features common to the primary vehicle user profile and a secondary vehicle user profile are prioritized in the merge profile, features of the primary vehicle user profile that are not present in the secondary vehicle user profile are not prioritized in the merge profile, and features of the secondary vehicle user profile that are not present in the primary vehicle user profile are not part of the merge profile.

15. The method of claim 1, wherein a primary vehicle user profile is associated with a primary driver of the vehicle, and any safety-related features in the merge profile correspond to the safety-related features of the primary vehicle user profile.

16. A method of managing vehicle user profiles for a vehicle, comprising the steps of:
prompting an occupant of the vehicle to initiate a merge of a plurality of vehicle user profiles;
receiving authorization to merge the plurality of vehicle user profiles;
analyzing feature information from the plurality of vehicle user profiles, wherein the feature information includes features from one or more feature categories;
adding matching features from each feature category of the one or more feature categories of the plurality of vehicle user profiles to a merge profile;
determining a preference for remaining features not matched in the prior adding step;
adding remaining features to the merge profile based on the determined preference; and
presenting features to the occupant of the vehicle based on the merge profile.

17. The method of claim 16, further comprising the step of presenting the occupant of the vehicle an option to cancel use of the merge profile.

18. The method of claim 17, wherein the option to cancel use of the merge profile is presented to the occupant of the vehicle via a mobile device.

19. A system for managing vehicle user profiles in a vehicle, comprising:
an infotainment system located at the vehicle;
a database containing a plurality of vehicle user profiles;
a profile analyzing tool configured to analyze feature information from the plurality of vehicle user profiles; and
a merge profile building tool configured to build a merge profile from the plurality of vehicle user profiles by adding matching features from one or more feature categories from each of the plurality of vehicle user profiles to the merge profile, wherein features of the merge profile are presented to one or more vehicle occupants through the infotainment system.

20. The system of claim 19, wherein the database, the profile analyzing tool, and the merge profile building tool are located at a back-end facility.
